(19) United States
(12) Patent Application Publication
(10) Pub. No.: US 2014/0317014 A1
(43) Pub. Date: Oct. 23, 2014

(54) Shipping Route Determination

(71) Applicant: CloudLogix, LLC, Denver, CO (US)

(72) Inventors: Robert K. Langhorne, III, Grapevine, TX (US); John Millhouse, Garran (AU)

(21) Appl. No.: 14/254,756

(22) Filed: Apr. 16, 2014

Related U.S. Application Data
(60) Provisional application No. 61/812,948, filed on Apr. 17, 2013.

(51) Int. Cl. G06Q 50/28

(52) U.S. Cl. CPC G06Q 50/28
USPC 705/338

(57) ABSTRACT

Various implementations described herein are directed to a non-transitory computer readable medium having stored thereon computer-executable instructions which, when executed by a computer, may cause the computer to receive data corresponding to a shipment. The computer may retrieve carrier data related to the shipment. The computer may retrieve local carrier rules related to the shipment. The computer may modify the carrier data using the local carrier rules. The computer may create one or more routes for the shipment using the modified carrier data.

### CROSS-REFERENCE TO RELATED APPLICATIONS

This application claims the benefit of U.S. Provisional Patent Application Ser. No. 61/812,948, filed Apr. 17, 2013 and titled SUPPLY CHAIN SOFTWARE, the disclosure of which is incorporated herein by reference.

### BACKGROUND

### Discussion of the Related Art

This section is intended to provide background information to facilitate a better understanding of various technologies described herein. As the section's title implies, this is a discussion of related art. That such art is related in no way implies that it is prior art. The related art may or may not be prior art. It should therefore be understood that the statements in this section are to be read in this light, and not as admissions of prior art.

Typically, when an organization is determining how a shipment should be shipped, the shipment is simply shipped using a route that has been used before, largely ignoring the possibility that better deals may be available. Alternatively, an organization can manually examine carrier schedules, tariff tables, and on-time performance statistics to determine the best route for a shipment, which takes an extended period of time.

### SUMMARY

Described herein are implementations of various technologies for a method for creating one or more routes for a shipment. In one implementation, a non-transitory computer-readable medium having stored thereon computer-executable instructions which, when executed by a computer, cause the computer to perform various actions. The actions may include receiving data corresponding to a shipment. The actions may include retrieving carrier data related to the shipment. The actions may include retrieving local carrier rules related to the shipment. The actions may include modifying the carrier data using the local carrier rules. The actions may also include creating one or more routes for the shipment using the modified carrier data.

Described herein are also implementations of various technologies for creating a route for a shipment beginning at a shipping node. In one implementation, a non-transitory computer-readable medium having stored thereon computer-executable instructions which, when executed by a computer, cause the computer to perform various actions. The actions may include receiving a confirmation that a shipment on a first route has arrived at a shipping node. The actions may include determining that the first route needs to be adjusted based on information pertaining to the first route. The actions may also include creating a second route for the shipment beginning at the shipping node based on the information pertaining to the first route.

Described herein are also implementations of various technologies for a method for creating one or more routes for a shipment. The method may include receiving data corresponding to a shipment. The method may include retrieving carrier data related to the shipment. The method may include retrieving local carrier rules related to the shipment. The method may include modifying the carrier data using the local carrier rules. The method may also include creating one or more routes for the shipment using the modified carrier data.

The above referenced summary section is provided to introduce a selection of concepts in a simplified form that are further described below in the detailed description section. The summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

Implementations of various technologies will hereafter be described with reference to the accompanying drawings. It should be understood, however, that the accompanying drawings illustrate only the various implementations described herein and are not meant to limit the scope of various technologies described herein.

FIG. 1 illustrates a flow diagram of a method for shipping route determination in accordance with implementations of various techniques described herein.

FIG. 2 illustrates a flow diagram of a method for shipment route modification using new information in accordance with implementations of various techniques described herein.

FIG. 3 illustrates a flow diagram of a method for shipment route modification at a node in accordance with implementations of various techniques described herein.

FIG. 4 illustrates a diagram of a shipping route in accordance with various implementations described herein.

FIG. 5 illustrates a shipment tracking display in accordance with various implementations described herein.

FIG. 6 illustrates a schematic diagram of a computing system in which the various technologies described herein may be incorporated and practiced.

### DETAILED DESCRIPTION

The discussion below is directed to certain specific implementations. It is to be understood that the discussion below is only for the purpose of enabling a person with ordinary skill in the art to make and use any subject matter defined now or later by the patent “claims” found in any issued patent herein.

It is specifically intended that the claimed invention not be limited to the implementations and illustrations contained herein, but include modified forms of those implementations including portions of the implementations and combinations of elements of different implementations as come within the scope of the following claims. It should be appreciated that in the development of any such actual implementation, as in any engineering or design project, numerous implementation-specific decisions must be made to achieve the developers' specific goals, such as compliance with system-related and business related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure. Nothing in this application is considered critical or essential to the claimed invention unless explicitly indicated as being “critical” or “essential.”

Reference will now be made in detail to various implementations, examples of which are illustrated in the accompanying drawings and figures. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, components, circuits and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the invention. The first object or step, and the second object or step, are both objects or steps, respectively, but they are not to be considered the same object or step.

The terminology used in the description of the present disclosure herein is for the purpose of describing particular implementations only and is not intended to be limiting of the present disclosure. As used in the description of the present disclosure and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context. As used herein, the terms “up” and “down”; “upper” and “lower”; “upwardly” and “downwardly”; “below” and “above”; and other similar terms indicating relative positions above or below a given point or element may be used in connection with some implementations of various technologies described herein.

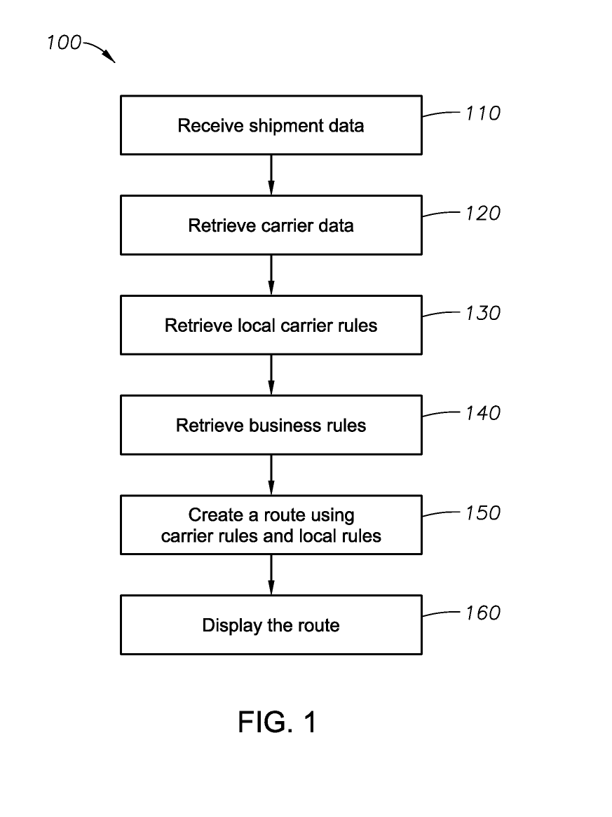

Various implementations of shipping route determination will now be described in more detail with reference to FIGS. 1-6.

The following paragraph provides a brief overview of various implementations described herein, which are directed to shipping route determination. A carrier-neutral shipping software may be used for routing, shipping, and managing shipments. In one implementation, the software may allow users to consolidate and ship consignments with approved carriers. In another implementation, the software may tender, track, and audit shipping invoices. In yet another implementation, the software may allow users to manage various carriers, shipments, and freight bills using only one application. The shipping software may be implemented as a cloud software service. Using this software, organizations may be able to reduce costs by identifying a route for a shipment in an efficient manner.

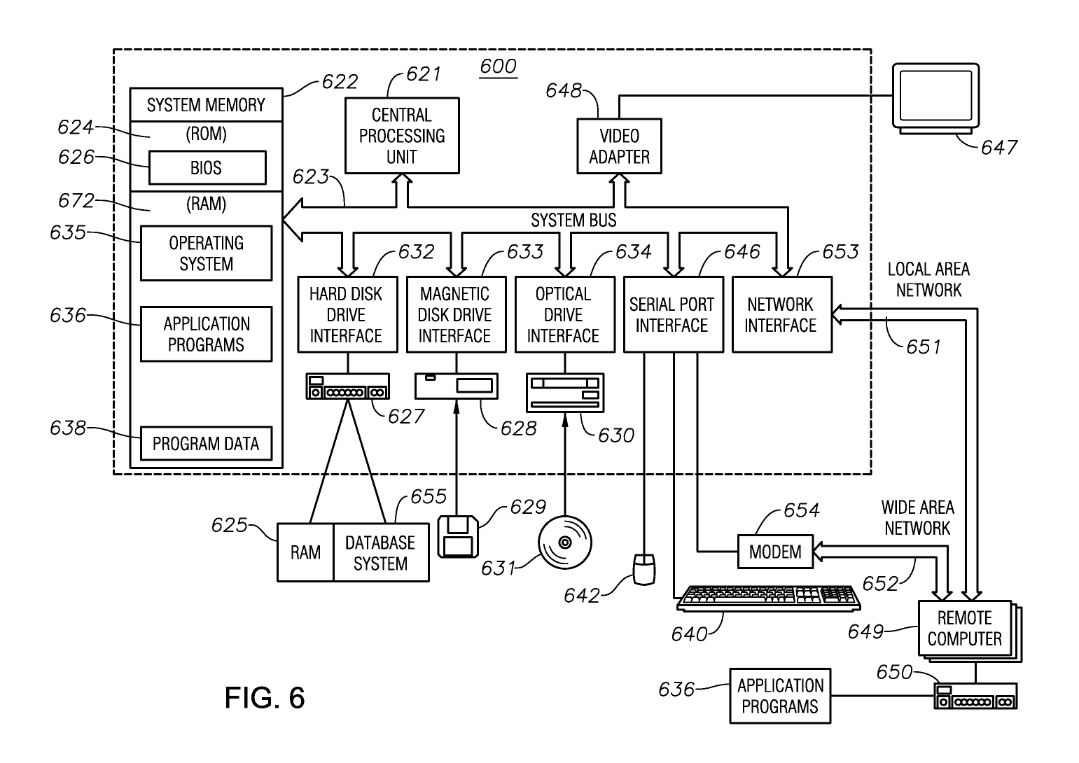

FIG. 1 illustrates a flow diagram of a method 100 for shipping route determination in accordance with implementations of various techniques described herein. In one implementation, method 100 may be performed by any computing device, such as computer system 600, described in FIG. 6. It should be understood that while the flow diagram in method 100 indicates a particular order of execution of operations, in some implementations, certain portions of the operations may be executed in a different order. Certain portions of the operations may be executed simultaneously. Further, in some implementations, additional operations or steps may be added to the flow diagram. Likewise, some operations or steps may be omitted. Additionally, the operations may be executed on more than one computerized device, and the computerized devices may be in more than one location.

At block 110, method 100 may receive shipment data. The data may include information describing the goods to be shipped, including the weight and size, the contents of the shipment, the originating location, the destination, the required pickup time and arrival time, and any other information regarding a shipment. In one implementation, the data is input by a user into an electronic form that transmits data to a cloud software service. In another implementation, the data is generated by a software service, such as a resource planner or transportation management system, and is then transmitted automatically to a cloud software service.

At block 120, the method may retrieve carrier data. The method may retrieve carrier data from one or more carriers. The data may be retrieved from a local database, or the data may be retrieved from the carrier. The data may include data describing the services offered by a carrier. The data may include the price to ship goods, timetables for shipment, carrier schedules, tariff tables, on-time performance statistics, service levels, or other information regarding available shipping services. For example, if the shipment data received at block 110 is for a package that needs to be shipped from Atlanta to Dallas, the carrier data retrieved at block 120 may include data detailing the cost of shipping the package from Atlanta to Dallas, the time required to ship the package from Atlanta to Dallas, the available pickup times for the package, and the corresponding delivery times.

In one implementation, instead of retrieving carrier data, method 100 may request carrier data from one or more carriers. For example, if the shipment data received at block 110 is for a vehicle that needs to be shipped from Italy to Canada, the method may request quotes from five different carriers, and may then receive five different quotes containing price, pickup time and date, and delivery time and date, i.e., carrier data, from the five different carriers.

At block 130, the method may retrieve local carrier rules. Local carrier rules may include corrections to a carrier's data, or local carrier rules may supplement a carrier's data. Local carrier rules may consist of rules that are manually input by users, and rules that are automatically created or learned. The local carrier rules may be automatically learned by examining past shipment tracking data. For example, a carrier's data may state that they retrieve packages from a warehouse at 9 am, 1 pm, and 5 pm daily, when in reality they only retrieve packages from that warehouse once a week, on Wednesdays at 3 pm. This error in the carrier's data may be known to the organization maintaining the local carrier rules (e.g., the owner of the warehouse), so the local carrier rules may include this correction to the carrier's data.

In another example, a carrier's data may include a service but not a price for the service. However, the price may be known locally from prior orders and stored in local carrier rules. As such, the local carrier rules could then be used to supplement the carrier's data, so that the carrier's data now includes the price for the service.

At block 140, the method may retrieve business rules. Business rules may be a set of rules used by an organization to describe the preferences of that organization in regards to various attributes of a shipment. Some business rules may be rules that must be followed in all circumstances, while other rules may be used when weighing different carriers and determining the best route for a shipment. In one implementation, business rules may be stored with an associated weight for each rule. For example, a company may have business rules that state that all packages must leave the warehouse within three days of packing. This is an example of a rule that must be followed in all circumstances.

The company may also have a business rule that states that it is preferred for orders to be delivered within five days of receiving the order. The business rule may also include an associated weight, which would indicate how important this preference is to the organization.

Attributes that may be used in business rules include price, delivery time and date, pickup time and date, reliability, ability to re-route shipments in progress, insurance, or other attributes. The business rules may relate to a specific carrier's data and services. For example, if one service provided by a carrier is often delayed, the business rules may instruct the method not to use that service, or to weigh against using that service.

At block 150, the method may use the carrier rules, local carrier rules, and business rules to create a route. The method may weigh different attributes, e.g., using the associated weights, defined within the business rules to determine the route. For example, if there are two carriers, one that will be faster and more expensive, and one that is slower and cheaper, the method may use the rules to determine which carrier would be selected based on how much weight is given to the attributes cost and delivery time.

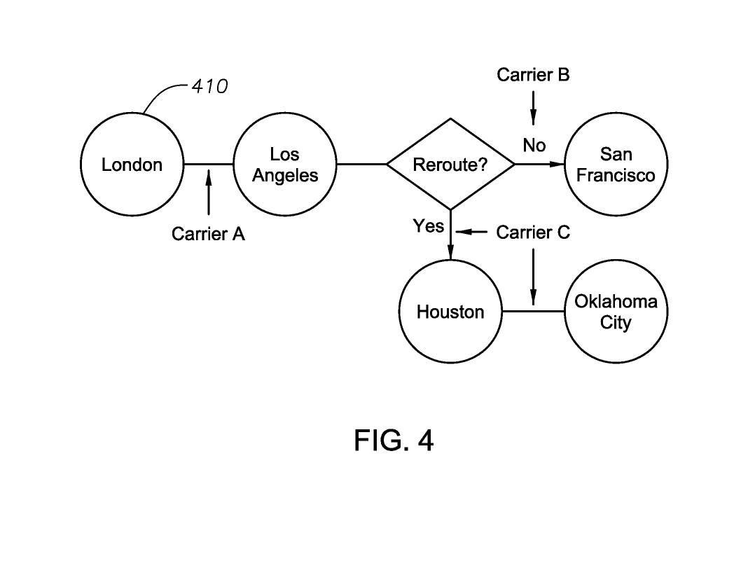

The created route may use one or more carriers, may have one or more modes of transportation, and may have one or more shipping nodes. A shipping node is any location that a shipment is held for a period of time. Shipping nodes may be defined by a carrier. Shipping nodes may be locations at which a shipment's shipping route can be modified while the shipment is in progress. For example, if a shipment travels from Dallas to Tulsa on an airplane, Dallas and Tulsa may both be shipping nodes. Or, in another example, if a shipment is shipped by train, every train station at which the train stopped may be a shipping node. FIG. 4 is an illustration of various shipping nodes located on a shipment's route.

In one implementation, the route may be created by displaying one or more suggested routes to a user. For example, a user interface may be created with a list of suggested routes, and the user may select a route or portions of multiple routes in order to create a route for the shipment. The displayed routes may be ranked using the business rules.

At block 160, the method may display the route created at block 150. In one implementation, the method may display the route to a user of a cloud software service implementing method 100. The display may be a series of instructions. The display may include order forms for the services used on the route.

In another implementation, the method may transmit the route to one or more carriers that provide services used on the route. The method may automatically order the shipping services used on the route. For example, a user may enter information describing a shipment, and method 100 may create the route, and then automatically send a shipping order to the carriers that are used in the route.

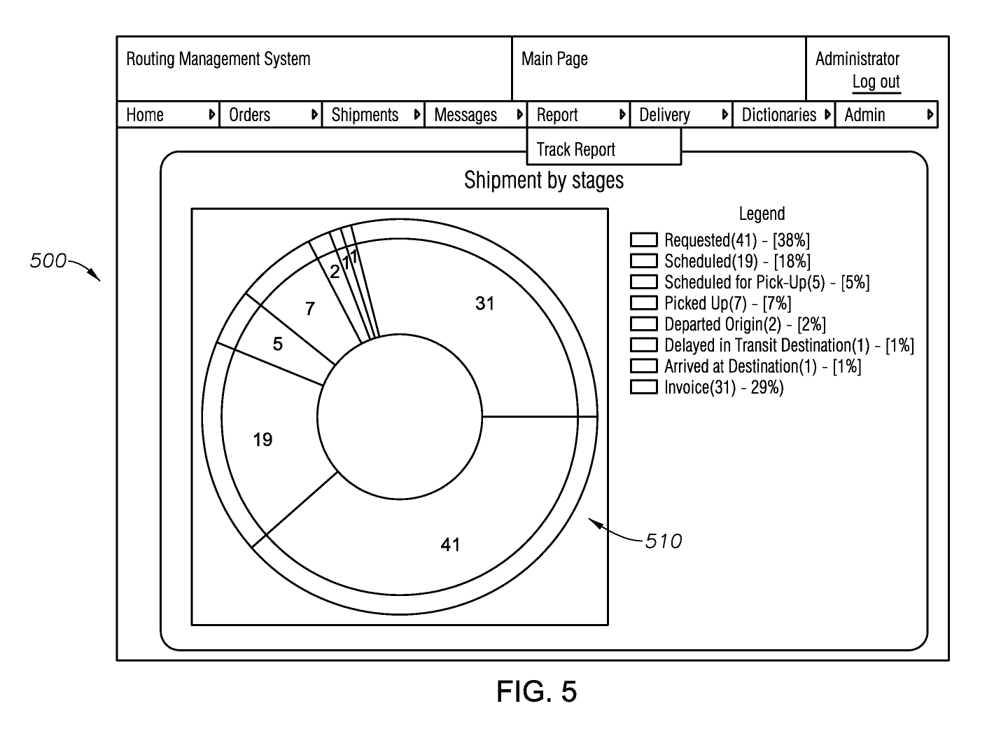

Additionally, at block 160, the route may be transmitted to a system that monitors shipments in order to monitor the shipment while the shipment is in transit. The monitoring system may be a cloud software service. A monitoring system is further discussed in FIG. 5.

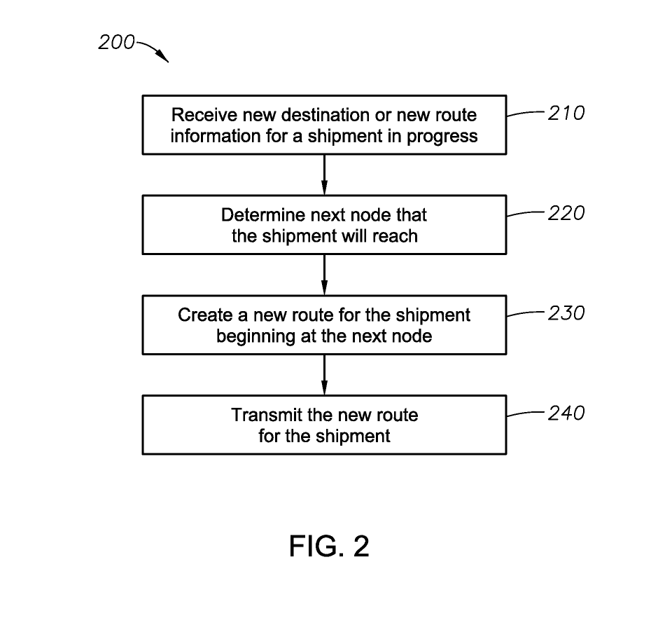

FIG. 2 illustrates a flow diagram of a method for shipment route modification using new information in accordance with implementations of various techniques described herein. In one implementation, these processes may be performed by any computing device, such as computer system 600, described in FIG. 6. It should be understood that while the flow diagram 200 indicates a particular order of execution of operations, in some implementations, certain portions of the operations may be executed in a different order. Certain portions of the operations may be executed simultaneously. Further, in some implementations, additional operations or steps may be added to the flow diagram 200. Likewise, some operations or steps may be omitted. Additionally, the operations may be executed on more than one computerized device, and the computerized devices may be in more than one location.

Method 200 may be used to modify a shipping route while a shipment is in progress. In one implementation, method 200 may be used whenever new information regarding a route is received or whenever a route needs to be modified, whether the shipment is at a node or in transit. At block 210, method 200 may receive a new destination for a shipment that is in progress, or new route information for the shipment. For example, method 200 may receive a notice that a strike is occurring at the Port of Los Angeles, and thus the Port of Los Angeles should be avoided.

At block 220, method 200 may determine the next shipping node that the shipment will reach. For example, if the shipment were currently traveling in an airplane from Tulsa to Houston, the next shipping node for the shipment would be Houston. In a second example, if the shipment were currently being held in Tulsa while waiting for a train to arrive, the shipping node would be the current shipping node, i.e., Tulsa.

At block 230, method 200 may create a new route for the shipment beginning at the next node, based on the new information received at block 210. The route may be created using method 100. For example, if a package with a next shipping node of Los Angeles was originally shipped with a destination of Dallas, but is now needed in Seattle, a new route may be created from Los Angeles to Seattle. Thus the package would travel from the next shipping node, Los Angeles, to the new destination, Seattle, without going to the original destination, Dallas, first.

In another example, a package is being shipped from Dallas to Boston, with stops at Little Rock and then Richmond. If a fire were to occur at Richmond causing delays for shipments traveling through Richmond, a new route could be generated at block 230 from Little Rock to Boston that avoids Richmond, thus avoiding any delays caused by the fire.

In one implementation, the shipment may be split, and a portion of the shipment may be shipped using the new route, and a portion may be shipped using the old route, or another new route. In one example, a shipment of one thousand books is traveling from New York to El Paso, with a stop in Memphis. New information could be received at block 210 with instructions for five hundred books to proceed to El Paso on the original route, and for five hundred books to proceed to Santa Fe, a new destination. A new route could be created at block 230 for five hundred of the books, beginning in Memphis and ending in Santa Fe. The other five hundred books could continue on the original route, from Memphis to El Paso.

At block 240, method 200 may transmit the new route for the shipment. In one implementation, method 200 may transmit the new route to a system of the next shipping node that the package will arrive at, or a system of the shipping node that the package is currently held at. Method 200 may also cancel the prior route, or the portions of the prior route that will no longer be used. For example, method 200 may transmit a message to the carriers for those portions being canceled, stating that their shipping services are not needed.

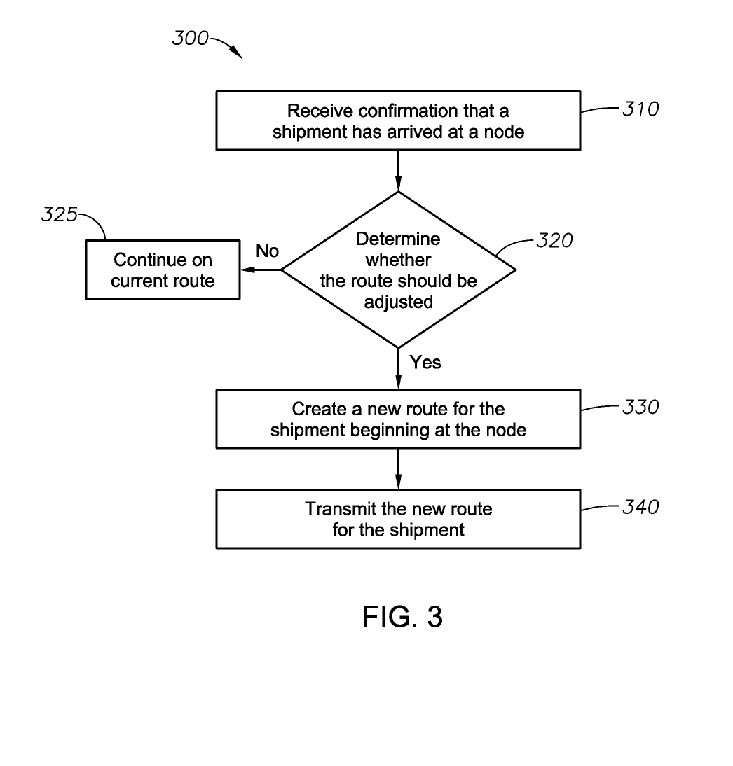

FIG. 3 illustrates a flow diagram of a method for shipment route modification at a node in accordance with implementations of various techniques described herein. In one implementation, these processes may be performed by any computing device, such as computer system 600, described in FIG. 6. It should be understood that while the flow diagram 300 indicates a particular order of execution of operations, in some implementations, certain portions of the operations may be executed in a different order. Certain portions of the operations may be executed simultaneously. Further, in some implementations, additional operations or steps may be added to the flow diagram 300. Likewise, some operations or steps may be omitted. Additionally, the operations may be executed on more than one computerized device, and the computerized devices may be in more than one location.

Method 300 may be used to determine whether the current shipping route should be modified or replaced, e.g., when a shipment is at a shipment node. In one implementation, method 300 may be executed each time a shipment arrives at a shipping node.

At block 310, method 300 may receive confirmation that a shipment has arrived at a shipping node. For example, a digital message may be received that includes an identification number of the shipment and location information corresponding to the shipping node.

In one implementation, at block 310, method 300 may determine when a shipment was scheduled to arrive at a shipping node by examining the shipment's route and finding when the shipment was scheduled to arrive at the shipping node. Although there may be no confirmation that the shipment has actually arrived, method 300 may use the scheduled arrival time at block 310 instead of a confirmation.

At block 320, method 300 may determine whether the route should be adjusted. Method 300 may examine whether there is any new information regarding the route, including potential delays, and also whether there is any other new information, such as a new destination for the shipment. At block 325, if there is no new information that causes the route to be adjusted, method 300 may be complete, and the shipment may continue on the current route. If the route does need to be adjusted because of the new information, method 300 may continue to block 330.

At block 330, method 300 may create a new route for the shipment beginning at the current shipping node. The route may be created using method 100. The route may include shipping nodes and carriers. The route may be a modification of the prior route, or may be a new route. In one implementation, the shipment may be split, and a portion of the shipment may be shipped using the new route, and a portion may be shipped using the old route, or another new route.

At block 340, method 300 may transmit the new route. In one implementation, method 300 may transmit the new route to a system at the shipping node where the shipment is located. Method 300 may also cancel the prior route, or the portions of the prior route that will no longer be used. For example, method 300 may transmit a message to the carriers for those portions being canceled, stating that their shipping services are not needed.

FIG. 4 illustrates a diagram of a shipping route in accordance with various implementations described herein. At block 410, a shipment may be created in London with a destination of San Francisco. Shipping route determination method 100 may be used to create a route for the shipment using the origin of London with the destination of San Francisco. Method 100 may examine carrier rules, local carrier rules, and business rules to determine the route for the shipment. A route may then be generated, where the shipment is to travel from London to Los Angeles, and then to the destination of San Francisco. The route includes the shipping nodes and carriers for the shipment. In FIG. 4, the shipment route includes shipping the shipment from London to Los Angeles by Carrier A, and from Los Angeles to San Francisco using Carrier B.

When the shipment arrives at Los Angeles, a shipping node, method 300 may be used to determine whether the route should be modified. A cloud software service may receive a message confirming that the shipment has arrived in Los Angeles, and may then automatically call method 300 to determine whether the shipment should be assigned a new route or a modified route. In one example, the shipment may now be needed in Oklahoma City, not San Francisco. A new route may be created at block 330 using the new information. The new route may then be transmitted to a user or system at the shipping node in Los Angeles. For example, the new route may be transmitted to whoever possesses the goods in Los Angeles. In this example, Carrier A may have possession of the goods in Los Angeles. The new route may also be transmitted to the carrier used on the new route, which in this example is Carrier C. In FIG. 4, the new route includes shipping the goods from Los Angeles to Houston using Carrier C, and then from Houston to Oklahoma City, also using Carrier C. A message may be transmitted to Carrier B, stating that the shipment no longer needs to be shipped from Los Angeles to San Francisco.

Alternatively, when the shipment arrives in Los Angeles, method 300 may determine at block 320 that the route should not be modified. Then, the shipment may be shipped by Carrier B to the original destination of San Francisco.

FIG. 5 illustrates a shipment tracking display 500 in accordance with various implementations described herein. In one implementation, a cloud software service is used to manage shipments. The cloud software service may implement methods 100, 200, 300, or combinations thereof to create and modify routes for the shipments. The cloud software service may receive updates regarding the shipments while the shipments are in transit. The cloud software service may display reports describing the shipments, including chart 510.

Chart 510 provides an overview of shipments managed by a cloud software service. In Chart 510, the cloud software service displays the number of shipments that are requested, are scheduled, are scheduled for pick-up, have been picked up, have departed from origin, are delayed in transit destination, have arrived at destination, and are invoiced. Portions of display 500 may be selected by a user to display more information. For example, a user may select the word “Scheduled” in display 500, or the corresponding portion of chart 510, and the cloud software service may then display a list of all scheduled shipments.

### Computing System

Implementations of various technologies described herein may be operational with numerous general purpose or special purpose computing system environments or configurations. Examples of well known computing systems, environments, and/or configurations that may be suitable for use with the various technologies described herein include, but are not limited to, personal computers, server computers, hand-held or laptop devices, multiprocessor systems, microprocessor-based systems, set top boxes, programmable consumer electronics, network PCs, minicomputers, mainframe computers, smart phones, and the like.

The various technologies described herein may be implemented in the general context of computer-executable instructions, such as program modules, being executed by a computer. Generally, program modules include routines, programs, objects, components, data structures, etc. that performs particular tasks or implement particular abstract data types. Further, each program module may be implemented in its own way, and all need not be implemented the same way. While program modules may all execute on a single computing system, it should be appreciated that, in some implementations, program modules may be implemented on separate computing systems or devices adapted to communicate with one another. A program module may also be some combination of hardware and software where particular tasks performed by the program module may be done either through hardware, software, or both.

The various technologies described herein may also be implemented in distributed computing environments, including a cloud computing environment, where tasks are performed by remote processing devices that are linked through a communications network, e.g., by hardwired links, wireless links, or combinations thereof. In a distributed computing environment, program modules may be located in both local and remote computer storage media including memory storage devices.

FIG. 6 illustrates a computer system 600 into which implementations of various technologies and techniques described herein may be implemented. Computing system 600 may be a conventional desktop, a handheld device, a controller, a personal digital assistant, a server computer, an electronic device/instrument, a laptop, a tablet, or part of a cloud computing system. It should be noted, however, that other computer system configurations may be used.

The computing system 600 may include a central processing unit (CPU) 621, a system memory 622 and a system bus 623 that couples various system components including the system memory 622 to the CPU 621. Although only one CPU is illustrated in FIG. 6, it should be understood that in some implementations the computing system 600 may include more than one CPU. The system bus 623 may be any of several types of bus structures, including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. The system memory 622 may include a read only memory (ROM) 624 and a random access memory (RAM) 625. A basic input/output system (BIOS) 626, containing the basic routines that help transfer information between elements within the computing system 600, such as during start-up, may be stored in the ROM 624. The computing system may be implemented using a printed circuit board containing various components including processing units, data storage memory, and connectors.

The computing system 600 may further include a hard disk drive 627 for reading from and writing to a hard disk, a magnetic disk drive 628 for reading from and writing to a removable magnetic disk 629, and an optical disk drive 630 for reading from and writing to a removable optical disk 631, such as a CD ROM or other optical media. The hard disk drive 627, the magnetic disk drive 628, and the optical disk drive 630 may be connected to the system bus 623 by a hard disk drive interface 632, a magnetic disk drive interface 633, and an optical drive interface 634, respectively. The drives and their associated computer-readable media may provide nonvolatile storage of computer-readable instructions, data structures, program modules and other data for the computing system 600.

Although the computing system 600 is described herein as having a hard disk, a removable magnetic disk 629 and a removable optical disk 631, it should be appreciated by those skilled in the art that the computing system 600 may also include other types of computer-readable media that may be accessed by a computer. For example, such computer-readable media may include computer storage media and communication media. Computer storage media may include volatile and non-volatile, and removable and non-removable media implemented in any method or technology for storage of information, such as computer-readable instructions, data structures, program modules or other data. Computer storage media may further include RAM, ROM, erasable programmable read-only memory (EPROM), electrically erasable programmable read-only memory (EEPROM), flash memory or other solid state memory technology, CD-ROM, digital versatile disks (DVD), or other optical storage, magnetic cassettes, magnetic tape, magnetic disk storage or other magnetic storage devices, or any other medium which can be used to store the desired information and which can be accessed by the computing system 600. Communication media may embody computer readable instructions, data structures, program modules or other data in a modulated data signal, such as a carrier wave or other transport mechanism and may include any information delivery media. By way of example, and not limitation, communication media may include wired media such as a wired network or direct-wired connection, and wireless media such as acoustic, RF, infrared and other wireless media. Combinations of any of the above may also be included within the scope of computer readable media.

A number of program modules may be stored on the hard disk 627, magnetic disk 629, optical disk 631, ROM 624 or RAM 625, including an operating system 635, one or more application programs 636, program data 638, and a database system 655. The one or more application programs 636 may contain program instructions configured to perform methods 100, 200, or 300 according to various implementations described herein. The operating system 635 may be any suitable operating system that may control the operation of a networked personal or server computer, such as Windows® XP, Mac OS® X, Unix-variants (e.g., Linux® and BSD®), and the like.

A user may enter commands and information into the computing system 600 through input devices such as a keyboard 640 and pointing device 642. Other input devices may include a microphone, joystick, game pad, satellite dish, scanner, user input button, or the like. These and other input devices may be connected to the CPU 621 through a serial port interface 646 coupled to system bus 623, but may be connected by other interfaces, such as a parallel port, game port or a universal serial bus (USB). A monitor 647 or other type of display device may also be connected to system bus 623 via an interface, such as a video adapter 648. In addition to the monitor 647, the computing system 600 may further include other peripheral output devices such as speakers and printers.

Further, the computing system 600 may operate in a networked environment using logical connections to one or more remote computers 649. The logical connections may be any connection that is commonplace in offices, enterprise-wide computer networks, intranets, and the Internet, such as local area network (LAN) 651 and a wide area network (WAN) 652. The remote computers 649 may each include application programs 636 similar to that as described above.

When using a LAN networking environment, the computing system 600 may be connected to the local network 651 through a network interface or adapter 653. When used in a WAN networking environment, the computing system 600 may include a modem 654, wireless router or other means for establishing communication over a wide area network 652, such as the Internet. The modem 654, which may be internal or external, may be connected to the system bus 623 via the serial port interface 646. In a networked environment, program modules depicted relative to the computing system 600, or portions thereof, may be stored in a remote memory storage device 650. It will be appreciated that the network connections shown are exemplary and other means of establishing a communications link between the computers may be used.

While the foregoing is directed to implementations of various techniques described herein, other and further implementations may be devised without departing from the basic scope thereof, which may be determined by the claims that follow.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A non-transitory computer-readable medium having stored thereon computer-executable instructions which, when executed by a computer, cause the computer to:
receive data corresponding to a shipment;
retrieve carrier data related to the shipment;
retrieve local carrier rules related to the shipment;
modify the carrier data using the local carrier rules; and
create one or more routes for the shipment using the modified carrier data.

2. The non-transitory computer-readable medium of claim 1, wherein the local carrier rules comprise corrections to a carrier's pickup times and dates described in the carrier data.

3. The non-transitory computer-readable medium of claim 1, wherein the local carrier rules comprise data that supplement the carrier data.

4. The non-transitory computer-readable medium of claim 1, further comprising instructions that cause the computer to retrieve business rules related to the shipment, and wherein the route for the shipment is created using the business rules.

5. The non-transitory computer-readable medium of claim 4, wherein the business rules comprise one or more shipment attributes with corresponding weights and the route for the shipment is created using the attributes and the corresponding weights.

6. The non-transitory computer-readable medium of claim 1, wherein the data corresponding to the shipment comprises a weight, size, origin location, destination location, shipping date and time, arrival date and time, or combinations thereof.

7. The non-transitory computer-readable medium of claim 1, wherein the carrier data describes shipping services provided by one or more carriers.

8. The non-transitory computer-readable medium of claim 1, wherein the carrier data describes shipping quotes provided by one or more carriers.

9. The non-transitory computer-readable medium of claim 1, further comprising instructions that cause the computer to:
retrieve business rules related to the shipment;
create a ranking for each of the one or more routes using the business rules;
display the one or more routes and the corresponding rank for each route; and
receive a selection from the one or more routes.

10. A non-transitory computer-readable medium having stored thereon computer-executable instructions which, when executed by a computer, cause the computer to:
receive a confirmation that a shipment on a first route has arrived at a shipping node;
determine that the first route needs to be adjusted based on information pertaining to the first route; and
create a second route for the shipment beginning at the shipping node based on the information pertaining to the first route.

11. The non-transitory computer-readable medium of claim 10, wherein the information pertaining to the first route comprises a new destination for the shipment.

12. The non-transitory computer-readable medium of claim 10, wherein the information pertaining to the first route comprises information corresponding to a delay at one or more shipping nodes on the first route.

13. The non-transitory computer-readable medium of claim 10, wherein the second route comprises a modification to the first route.

14. The non-transitory computer-readable medium of claim 10, wherein the information pertaining to the first route comprises a new destination for only a portion of the shipment.

15. The non-transitory computer-readable medium of claim 10, further comprising instructions that cause the computer to place an order for shipping services at one or more carriers on the second route.

16. The non-transitory computer-readable medium of claim 10, wherein the instructions to create the second route for the shipment comprises instructions that cause the computer to:
retrieve carrier data related to the shipment;
retrieve local carrier rules related to the shipment;
modify the carrier data using the local carrier rules; and
create the second route for the shipment using the modified carrier data.

17. The non-transitory computer-readable medium of claim 10, wherein instructions to receive the confirmation that the shipment on the first route has arrived comprises instructions that cause the computer to examine the first route to determine when the shipment is scheduled to arrive at the shipping node.

18. A method for creating one or more routes for a shipment, comprising:
receiving data corresponding to a shipment;
retrieving carrier data related to the shipment;
retrieving local carrier rules related to the shipment;
modifying the carrier data using the local carrier rules; and
creating one or more routes for the shipment using the modified carrier data.

19. The method of claim 18, wherein the local carrier rules comprise corrections to a carrier's pickup times and dates described in the carrier data.

20. The method of claim 18, further comprising:
retrieving business rules related to the shipment creating a ranking for each of the one or more routes using the business rules;
displaying the one or more routes and the corresponding rank for each route; and
receiving a selection from the one or more routes.
